(19) United States
(12) Patent Application Publication
(10) Pub. No.: US 2009/0062412 A1
(43) Pub. Date: Mar. 5, 2009

(54) POLYMER BLENDS COMPOSED OF POLYESTERS AND OF LINEAR, OLIGOMERIC POLYCARBONATES

(75) Inventors: Andreas Eipper, Ludwigshafen (DE); Bernd Bruchmann, Freinsheim (DE); Carsten Weiss, Ludwigshafen (DE); Jean-Francois Stumbe, Strasbourg (FR)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/719,157

(22) PCT Filed: Nov. 5, 2005
(86) PCT No.: PCT/EP05/11850

§ 371 Date: May 11, 2007

(30) Foreign Application Priority Data
Nov. 11, 2004 (DE) 10 2004 054 632.0

(51) Int. Cl. C08L 67/02

(52) U.S. Cl. 521/138; 525/418

(57) ABSTRACT

Polymer blend, comprising components A) to C), the entirety of which gives 100% by weight,
A) from 30 to 99.99% by weight of at least one polyester A),
B) from 0.01 to 70% by weight of at least one linear, oligomeric polycarbonate B),
C) from 0 to 80% by weight of other additives C).

The invention relates to a polymer blend, comprising components A) to C), the entirety of which gives 100% by weight,
A) from 30 to 99.99% by weight of at least one polyester A),
B) from 0.01 to 70% by weight of at least one linear, oligomeric polycarbonate B), and
C) from 0 to 80% by weight of other additives C).

The invention also relates to the use of the polymer blends for production of moldings, of films, of fibers, or of foams, and to the moldings, films, fibers, or foams obtainable from the polymer blend. Finally, the invention relates to the use of linear, oligomeric polycarbonates as defined as component B), for increasing the flowability of polyesters.

The balanced mechanical properties, high chemicals resistance, good heat resistance, and good dimensional stability of polyesters, such as polybutylene terephthalate (PBT) or polyethylene terephthalate (PET) give them a wide variety of fields of application, e.g. as engineering components in motor vehicles, or in electrical and electronic devices, in precision engineering, and in mechanical engineering. PET is also used for bottles, trays, cups, and other packaging. These moldings are usually produced in the injection molding process and are often mass-produced. In order to shorten cycle time during injection molding, high flowability of the polymer is desirable. This is usually achieved via addition of lubricants, of mineral oils (white oil), or of polymers with low molecular weight, or oligomers. However, these flow improvers markedly impair mechanical properties, heat resistance (Vicat), and dimensional stability.

Polymer blends composed of polyesters and of conventional polycarbonates are known, cf. by way of example EP-A 846 729, DE-A 3004942, and DE-A 2343609. The polycarbonates used in these blends are, by way of example, prepared from diphenyl carbonate and bisphenol A or from other aromatic dihydroxy compounds, and their relative viscosity ηᵣₑₗ is generally from 1.1 to 1.5, in particular from 1.28 to 1.4 (measured at 25° C. in a 0.5% strength by weight solution in dichloromethane). This corresponds to a weight-average molar mass of from 10 000 to 200 000 g/mol for the polycarbonate, or viscosity numbers VN of from 20 to 100 ml/g, measured to DIN 53727 at 23° C. on the solution mentioned. These are therefore high-molecular-weight polycarbonates.

An object was to eliminate the disadvantages described. In particular, alternate polymer mixtures (blends) based on polyesters such as PBT or PET should be provided and should feature good flowability. The flow improver should be capable of easy preparation.

The good flowability should be achieved while retaining the good mechanical and thermal properties of the polyesters. In particular, the level of mechanical properties (such as modulus of elasticity, tensile strain at break and tensile strain at yield, tensile stress at break, and impact resistance) and dimensional stability should be similar to those found in polyesters without flow improver.

Accordingly, the polymer blends defined at the outset have been found, as have the use mentioned of these and the moldings, films, fibers, or foams composed of the polymer blends. The use of the linear, oligomeric polycarbonates B) for increasing the flowability of polyesters has also been found. Preferred embodiments of the invention are given in the subclaims.

The polymer blend comprises
A) from 30 to 99.99% by weight, preferably from 50 to 99.9% by weight, in particular from 70 to 99.7% by weight, and particularly preferably from 90 to 99.5% by weight, of the polyester A),
B) from 0.01 to 70% by weight, preferably from 0.1 to 50% by weight, in particular from 0.3 to 30% by weight, and particularly preferably from 0.5 to 10% by weight, of the linear, oligomeric polycarbonate B), and
C) from 0 to 80% by weight, preferably from 0 to 50% by weight, and particularly preferably from 0 to 40% by weight, of additives C),
   the amounts within the above ranges having been selected in such a way that the entirety of the constituents A) to C) is 100% by weight. Component C) is optional.

### Polyester A)

Suitable components A) are any of the polyesters known to the person skilled in the art. Preference is given to aromatic (semiaromatic and completely aromatic) polyesters. Use is generally made of polyesters A) based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety. Polyalkylene terephthalates of this type are known per se and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl groups, such as methyl, ethyl, iso- or n-propyl, or n-, iso- or tert-butyl groups.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters A) are polyalkylene terephthalates derived from alkanediols having from 2 to 6 carbon atoms. Among these, particular preference is given to polyethylene terephthalate (PET), polypropylene terephthalate and polybutylene terephthalate (PBT), and mixtures of these. PET and PBT are particularly preferred.

Preference is also given to PET and/or PBT which comprise, as other monomer units, up to 1% by weight, preferably up to 0.75% by weight, of 1,6-hexanediol and/or 2-methyl-1,5-pentanediol.

The viscosity number of the polyesters A) is generally in the range from 50 to 220, preferably from 80 to 160 (measured in 0.5% strength by weight solution in a phenol/o-dichlorobenzene mixture in a weight ratio of 1:1 at 25° C.) in accordance with ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. Carboxy end group content is usually determined by titration methods (e.g. potentiometry).

Particularly preferred molding compositions comprise, as component A), a mixture of polyesters other than PBT, for example polyethylene terephthalate (PET). The proportion of the polyethylene terephthalate, for example, in the mixture is preferably up to 50% by weight, in particular from 10 to 35% by weight, based on 100% by weight of A).

It is also advantageous to use recycled PET materials (also termed scrap PET), if appropriate mixed with polyalkylene terephthalates, such as PBT.

Recycled materials are generally:
1) those known as post-industrial recycled materials: these are production wastes during polycondensation or during processing, e.g. sprues from injection molding, start-up material from injection molding or extrusion, or edge trims from extruded sheets or films.
2) post-consumer recycled materials: these are plastic items which are collected and treated after utilization by the end consumer. Blow-molded PET bottles for mineral water, soft drinks and juices are easily the predominant items in terms of quantity.

Both types of recycled material may be used either as ground material or in the form of pellets. In the latter case, the crude recycled materials are separated and purified and then melted and pelletized using an extruder. This usually facilitates handling and free flow, and metering for further steps in processing.

The recycled materials used may either be pelletized or in the form of ground material. The edge length should not be more than 10 mm, preferably less than 8 mm. Because polyesters undergo hydrolytic cleavage during processing (due to traces of moisture) it is advisable to predry the recycled material. The residual moisture content after drying is preferably <0.2%, in particular <0.05%.

Another group to be mentioned is that of fully aromatic polyesters deriving from aromatic dicarboxylic acids and aromatic dihydroxy compounds. Suitable aromatic dicarboxylic acids are the compounds previously mentioned for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

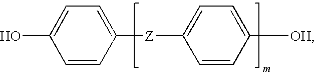

where Z is an alkylene or cycloalkylene group having up to 8 carbon atoms, an arylene group having up to 12 carbon atoms, a carbonyl group, a sulfonyl group, an oxygen atom or a sulfur atom, or a chemical bond, and m is from 0 to 2. The phenylene groups of the compounds may also have substitution by C₁-C₆-alkyl or alkoxy groups and fluorine, chlorine or bromine.

Examples of parent compounds for these compounds are
dihydroxybiphenyl,
di(hydroxyphenyl)alkane,
di(hydroxyphenyl)cycloalkane,
di(hydroxyphenyl) sulfide,
di(hydroxyphenyl)ether,
di(hydroxyphenyl)ketone,
di(hydroxyphenyl)sulfoxide,
α,α′-di(hydroxyphenyl)dialkylbenzene,
di(hydroxyphenyl) sulfone, di(hydroxybenzoyl)benzene,
resorcinol, and
hydroquinone, and also the ring-alkylated and ring-halogenated derivatives of these.

Among these, preference is given to
4,4′-dihydroxybiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and in particular to
2,2-di(4′-hydroxyphenyl)propane,
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
   and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

The polyester A) used may also take the form of a prepolymer A′, which is post-condensed after mixing with components B) and, if appropriate, C) (see a later stage below).

According to the invention, polyesters A) also include halogen-free polycarbonates. Examples of suitable halogen-free polycarbonates are those based on diphenols of the general formula

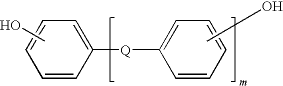

where Q is a single bond, a C₁-C₈-alkylene group, a C₂-C₃-alkylidene group, a C₃-C₆-cycloalkylidene group, a C₆-C₁₂-arylene group, or —O—, —S— or —SO₂—, and m is a whole number from 0 to 2.

For the purposes of the present invention, halogen-free polycarbonates are polycarbonates composed of halogen-free diphenols, of halogen-free chain terminators, and, if appropriate, of halogen-free branching agents. The content of low ppm amounts of hydrolyzable chlorine here, resulting by way of example from the preparation of the polycarbonates using phosgene in the interfacial process, not being regarded as halogen-comprising for the purposes of the invention. These polycarbonates with ppm contents of hydrolyzable chlorine are halogen-free polycarbonates for the purposes of the present invention.

The phenylene radicals of the diphenols may also have substituents, such as C₁-C₆-alkyl or C₁-C₆-alkoxy. Examples of preferred diphenols of the above formula are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethyl-cyclohexane.

Either homopolycarbonates or copolycarbonates are suitable as polyester A, and preference is given to the copolycarbonates of bisphenol A, as well as to bisphenol A homopolymer.

Polycarbonates suitable as component A) may be branched in a known manner, specifically and preferably by incorporating 0.05 to 2.0 mol %, based on the total of the biphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to an average molar mass M_{w} (weight-average) of from 10 000 to 200 000 g/mol, preferably from 20 000 to 80 000 g/mol.

The diphenols of the above general formula are known per se or can be prepared by known processes. The polycarbonates may, for example, be prepared by reacting the diphenols with phosgene in the interfacial process, or with phosgene in the homogeneous-phase process (known as the pyridine process), and in each case the desired molecular weight is achieved in a known manner by using an appropriate amount of known chain terminators. (In relation to polydiorganosiloxane-comprising polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

Other suitable components A) which may be mentioned are amorphous polyester carbonates, where during the preparation process phosgene has been replaced by aromatic dicarboxylic acid units, such as isophthalic acid and/or terephthalic acid units. Reference may be made to EP-A 711 810 for further details.

EP-A 365 916 describes other suitable copolycarbonates having cycloalkyl radicals as monomer units. It is also possible for bisphenol A to be replaced by bisphenol TMC. Polycarbonates of this type are obtainable from Bayer with the trademark APEC HT®.

### Polycarbonates B)

According to the invention, the polycarbonates B) have a linear structure, i.e. have only a low level of branching, or have no branching at all. This distinguishes them from highly branched or hyperbranched polycarbonates.

Likewise according to the invention, the polycarbonates are oligomers. The number-average molar mass Mn of the oligomeric polycarbonates is preferably from 250 to 200 000 g/mol, particularly preferably from 250 to 100 000 g/mol, and in particular from 300 to 20 000 g/mol, and very particularly preferably from 300 to less than 10 000 g/mol. The weight-average molar mass Mw is preferably from 280 to 300 000 g/mol, particularly preferably from 280 to 200 000 g/mol, and in particular from 350 to 50 000 g/mol.

The Mw/Mn ratio is usually from 1.1 to 10, preferably from 1.2 to 8, and particularly preferably from 1.3 to 5. The molar masses mentioned may, by way of example, be determined via gel permeation chromatography (GPC) or other suitable methods.

The polycarbonates B) preferably have a melting point or glass transition temperature of from −20 to 120° C., in particular from −10 to 100° C., and very particularly preferably from 0 to 80° C., determined using differential scanning calorimetry (DSC) to ASTM 3418/82.

The polycarbonates B) are preferably obtained by reacting a diol with an organic carbonate.

The polycarbonates may be aromatic or aliphatic. By way of example, aromatic poly-carbonates can be obtained by the processes of DE-B1 300 266 via interfacial polycondensation, or by the process of DE-A 14 95 730 via reaction of diphenyl carbonate (as organic carbonate) with bisphenols (as diol). Preferred bisphenol is 2,2-di(4-hydroxyphenyl)propane, generally termed bisphenol A.

Instead of bisphenol A, it is also possible to use other aromatic dihydroxy compounds, in particular 2,2-di(4-hydroxyphenyl)pentane, 2,6-dihydroxynaphthalene, 4,4′-di-hydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane, or 4,4-dihydroxy-biphenyl, or else a mixture of the abovementioned dihydroxy compounds.

Particularly preferred aromatic polycarbonates are those based on bisphenol A or bisphenol A together with up to 30 mol % of the abovementioned aromatic dihydroxy compounds.

Other, particularly preferred aromatic or aliphatic carbonates—termed carbonates i) below—for preparation of the polycarbonates are those of the formula RO[(CO)O]ₙR, where n=a whole number from 1 to 5, preferably from 1 to 3. Each of the radicals R is, independently of the others, a straight-chain or branched aliphatic, aromatic/aliphatic, or aromatic hydrocarbon radical having from 1 to 20 carbon atoms. The two radicals R may also have bonding to one another to form a ring. Preference is given here to an aliphatic hydrocarbon radical and particular preference is given to a straight-chain or branched alkyl radical having from 1 to 5 carbon atoms, or a substituted or unsubstituted phenyl radical.

The carbonates i) may preferably comprise simple carbonates of the general formula RO(CO)OR, i.e. n here is 1.

Dialkyl or diaryl carbonates i) may, by way of example, be prepared from the reaction of aliphatic, araliphatic, or aromatic alcohols or, respectively, phenols, preferably monoalcohols, with phosgene. However, they may also be prepared via oxidative carbonylation of the alcohols or phenols by means of CO in the presence of noble metals, oxygen, or nitrogen oxides NOₓ. See also “Ullmann's Encyclopedia of Industrial Chemistry”, 6th Edition, 2000 Electronic Release, Verlag Wiley-VCH for methods of preparing diaryl or dialkyl carbonates.

Examples of suitable carbonates i) comprise aliphatic, aromatic/aliphatic, or aromatic carbonates, e.g. ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates i) where n is greater than 1 comprise dialkyl dicarbonates, such as di(tert-butyl) dicarbonate, or dialkyl tricarbonates, such as di(tert-butyl) tricarbonate.

It is preferable to use aliphatic carbonates, in particular those where the radicals comprise from 1 to 5 carbon atoms, examples being dimethyl carbonate, diethyl carbonate, dipropyl carbonate, dibutyl carbonate, or diisobutyl carbonate, or diphenyl carbonate as aromatic carbonate.

Particularly preferred organic carbonates i) are dimethyl carbonate, diethyl carbonate, and mixtures of these.

The organic carbonates i) are reacted with at least one aliphatic or aromatic diol—termed diol ii) below—to give the polycarbonate B). The term diol or diol ii) here means any of the compounds having two OH groups, even if in particular instances they are not diols according to the nomenclature rules.

Suitable diols ii) have from 3 to 20 carbon atoms. Examples are ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, 1,7-heptanediol, 1,8-octanediol, 2-methyl-1,3-propanediol, 2,2-diethyl-1,3-propanediol, 3-methyl-1,5-pentanediol, 2-methylpentanediol, 2,2,4-trimethyl-1,6-hexanediol, 3,3,5-trimethyl-1,6-hexanediol, 2,3,5-trimethyl-1,6-hexanediol, cyclopentanediol, cyclohexanediol, cyclohexanedimethanol, bis(4-hydroxycyclohexyl)methane, bis(4-hydroxycyclohexyl)ethane, 2,2-bis(4-hydroxycyclohexyl)-propane, 1,1′-bis(4-hydroxyphenyl)-3,3,5-trimethylcyclohexane, resorcinol, hydroquinone, 4,4′-dihydroxybiphenyl, bis(4-hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxybenzophenone, dihydric polyetherpolyols based on ethylene oxide, propylene oxide, butylene oxide, or a mixture of these, polytetrahydrofuran, polycaprolactone, or polyesterols based on diols and dicarboxylic acids.

It is also possible to use adducts of the diols ii) with lactones (esterdiols), e.g. caprolactone or valerolactone. Other suitable compounds are adducts of the diols ii) with dicarboxylic acids, such as adipic acid, glutaric acid, succinic acid, or malonic acid, or adducts of the diols with esters of these dicarboxylic acids.

Particularly preferred diols ii) are 1,3-propanediol and 2,2-diethyl-1,3-propanediol.

The presence of compounds having three or more OH groups, e.g. triols, is to be avoided or kept to very low levels, because otherwise branched, and therefore undesired, polycarbonates can be produced.

The reaction (condensation) of the organic carbonate i) with the diol ii) preferably takes place in the presence of catalysts, and in principle any of the soluble or insoluble catalysts known for transesterification reactions can be used here. Examples of suitable catalysts are the hydroxides, oxides, metal alcoholates, carbonates, hydrogen-carbonates, and organometallic compounds of the metals of the 1st, 2nd, 3rd, and 4th main group of the Periodic Table, and of the 3rd and 4th transition group, other examples being the rare earth metals. Compounds of Li, Na, K, Cs, Mg, Ca, Ba, Al, Ti, Zr, Pb, Sn, Zn, Bi, and Sb are particularly suitable.

Other catalysts which may be used are tertiary amines, guanidines, ammonium compounds, phosphonium compounds, and those known as double metal cyanide (DMC) catalysts, as described by way of example in DE-A 10138216 or DE-A 10147712.

Examples of particularly suitable catalysts are LiOH, Li₂CO₃, K₂CO₃, KOH, NaOH, KOMe, NaOMe, MeOMgOAc, CaO, BaO, KOtBu, TiCl₄ (where Me is methyl, Ac is acetate, and tBu is tert-butyl), titanium tetraalcoholates, titanium terephthalates, zirconium tetraalcoholates, tin octanoates, dibutyltin dilaurate, dibutyltin, bis(tributyltin oxide), tin oxalates, lead stearates, Sb₂O₃, Zr tetraisopropoxide, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, tin dioctoate, and zirconium acetyl-acetonate, or a mixture of these.

It is preferable to use potassium hydroxide, potassium carbonate, potassium hydrogencarbonate, or a mixture of these.

The amount of catalyst is usually from 50 to 10 000 ppm by weight, preferably from 100 to 5000 ppm by weight, based on the diol used.

The reaction of the starting materials to give the polycarbonate B) usually takes place at a temperature of from 0 to 300° C., preferably from 0 to 250° C., particularly preferably at from 60 to 200° C., and very particularly preferably at from 60 to 160° C., and at a pressure of from 0.1 mbar to 20 bar, preferably from 1 mbar to 5 bar, in reactors or reactor cascades, which are operated batchwise, semicontinuously, or continuously.

By way of example, the reaction may be conducted in bulk or in solution. Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one preferred embodiment, the reaction is carried out in bulk. The phenol or the monohydric alcohol ROH can be removed, for example by distillation, from the reaction equilibrium to accelerate the reaction, if appropriate at reduced pressure. If removal by distillation is intended, it is generally advisable to use those carbonates which, during the reaction, liberate alcohols or phenols ROH with boiling point below 140° C. at the prevailing pressure.

There are various ways of terminating the intermolecular polycondensation reaction. By way of example, the temperature may be lowered to a range where the reaction stops. It is also possible to deactivate the catalyst, for example in the case of basic catalysts via addition of an acidic component, for example of a Lewis acid or of an organic or inorganic protonic acid.

Further information on preparation of the polycarbonates B) is found by way of example in WO 01/94444 and WO 03/002630.

The average molecular weight Mn or Mw of the polycarbonate B) can be adjusted by way of the constitution of the starting components and by way of the residence time.

The linear, oligomeric polycarbonates B) may be used as they stand or in the form of a mixture with the other polymers described below as component C). Polymer mixtures composed of linear, oligomeric polycarbonates B) and of conventional polyesters A), such as polybutylene terephthalate (PBT) are commercially available as Ultradur® High Speed from BASF.

### Other Additives C)

Additives C) which may be used are in particular any of the conventional plastics additives, and also polymers other than components A) and B).

The inventive molding compositions may comprise, as component C), from 0 to 5% by weight, preferably from 0.05 to 3% by weight, and in particular from 0.1 to 2% by weight, of at least one ester or amide of saturated or unsaturated aliphatic carboxylic acids having from 10 to 40, preferably from 16 to 22, carbon atoms with saturated aliphatic alcohols or amines having from 2 to 40, preferably from 2 to 6, carbon atoms.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol. The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glyceryl distearate, glyceryl tristearate, ethylenediamine distearate, glyceryl monopalmitate, glyceryl trilaurate, glyceryl monobehenate, and pentaerythrityl tetrastearate.

It is also possible to use mixtures of various esters or amides, or esters with amides combined, the mixing ratio here being as desired.

Examples of amounts of other usual additives C) are up to 40% by weight, preferably up to 30% by weight, of elastomeric polymers (also often termed impact modifiers, elastomers, or rubbers). These are preferably copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977). Some preferred types of such elastomers are described below.

Preferred elastomers are those known as ethylene-propylene (EPM) and ethylene-propylene-diene (EPDM) rubbers. EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenyl-norbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl(meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I, II, III or IV:

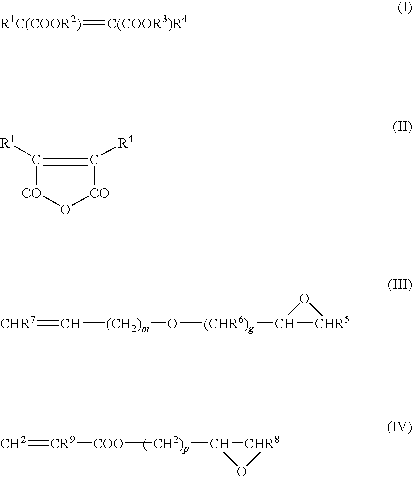

where R¹ to R⁹ are hydrogen or alkyl groups having from 1 to 6 carbon atoms, and m is a whole number from 0 to 20, g is a whole number from 0 to 10 and p is a whole number from 0 to 5. R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of from 50 to 98% by weight, in particular from 55 to 95% by weight, of ethylene; from 0.1 to 40% by weight, in particular from 0.3 to 20% by weight, of glycidyl acrylate and/or glycidyl methacrylate, (meth)acrylic acid, and/or maleic anhydride; and from 1 to 45% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters. Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion polymerization”, Applied Science Publ., London 1973. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

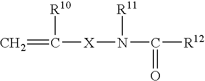

where the substituents may be defined as follows:
R¹⁰ is a hydrogen atom or C₁-C₄-alkyl group,
R¹¹ is a hydrogen atom or C₁-C₈-alkyl group or aryl group, in particular phenyl,
R¹² is a hydrogen atom, C₁-C₁₀-alkyl group, C₆-C₁₂-aryl group or —OR¹³
R¹³ is a C₁-C₁₀-alkyl group or C₆-C₁₂-aryl group, if desired with substitution by O- or N-comprising groups,
X is a chemical bond or C₁-C₁₀-alkylene group or C₆-C₁₂-arylene group, or

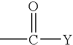

Y is O-Z or NH-Z, and
Z is a C₁-C₁₀-alkylene group or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n- | styrene, acrylonitrile, methyl |
| | butyl acrylate, ethylhexyl | methacrylate |
| | acrylate, or a mixture of | |
| | these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having reactive |
| | | groups, as described herein |
| V | styrene, acrylonitrile, | first envelope composed of mono- |
| | methyl methacrylate, or a | mers as described under I and II |
| | mixture of these | for the core, second envelope as |
| | | described under I or IV for the |
| | | envelope |

These graft polymers, in particular ABS polymers and/or ASA polymers, are preferably used in amounts of up to 40% by weight for the impact-modification of PBT, if appropriate in a mixture with up to 40% by weight of polyethylene terephthalate. Blend products of this type are obtainable with the trademark Ultradur®S (previously Ultrablend®S from BASF).

Instead of graft polymers whose structure has more than one shell, it is also possible to use homogeneous, i.e. single-shell, elastomers composed of 1,3-butadiene, isoprene and n-butyl acrylate or from copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the above-mentioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Fibrous or particulate fillers C) which may be mentioned are carbon fibers, glass fibers, glass beads, amorphous silica, asbestos, calcium silicate, calcium metasilicate, magnesium carbonate, kaolin, chalk, powdered quartz, mica, barium sulfate and feldspar, used in amounts of up to 50% by weight, in particular up to 40% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

Particular preference is given to mixtures of glass fibers C) with component B) in a ratio of from 1:100 to 1:2, preferably from 1:10 to 1:3.

The fibrous fillers may have been surface-pretreated with a silane compound to improve compatibility with the thermoplastic. Suitable silane compounds have the general formula:

(X—(CH₂)ₙ)ₖ—Si—(O—CₘH₂ₘ₊₁)₄₋ₖ

where the substituents are as defined above:

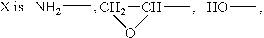

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.05 to 5% by weight, preferably from 0.5 to 1.5% by weight and in particular from 0.8 to 1% by weight (based on C)).

Acicular mineral fillers are also suitable. For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if desired, have been pretreated with the abovementioned silane compounds, but the pretreatment is not essential.

Other fillers which may be mentioned are kaolin, calcined kaolin, wollastonite, talc and chalk.

As component C), the thermoplastic molding compositions of the invention may comprise the usual processing aids, such as stabilizers, oxidation retarders, agents to counteract decomposition due to heat and decomposition due to ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 carbon atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzene-sulfonamide.

The inventive polymer blends may also comprise from 0 to 2% by weight of fluorine-comprising ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-comprising ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-comprising ethylene polymers and the incorporation of these into a polyester melt.

### Preparation and Properties of Polymer Blends

The inventive polymer blends may be prepared by methods known per se, by mixing the starting components in conventional mixing apparatus, such as screw extruders, Brabender mixers or Banbury mixers, and then extruding them. The extrudate may then be cooled and comminuted. It is also possible to premix individual components and then to add the remaining starting materials individually and/or likewise in a mixture. The mixing temperatures are generally from 230 to 290° C.

In another preferred procedure, components B) and, if appropriate, C) may be mixed with a polyester prepolymer A′), compounded, and pelletized. The resultant pellets are then solid-phase condensed under an inert gas continuously or batchwise at a temperature below the melting point of component A) until the desired viscosity has been reached.

The inventive polymer blends feature good flowability together with good mechanical properties, high heat resistance, high chemicals resistance, and good dimensional stability.

In particular, the individual components can be processed without difficulty (without clumping or caking) and in short cycle times, permitting in particular an application as thin-walled components.

The invention also provides the use of the inventive polymer blends for production of moldings, of films, of fibers, or of foams, and the moldings, films, fibers, or foams obtainable from the polymer blend.

The inventive improved-flow polyester can be used in almost any injection molding application. Because of the improved flow, the melt temperature can be lower and therefore the entire cycle time for the injection molding process can be lowered considerably (lowering the production costs of an injection molding). Furthermore, lower injection pressures are needed during processing, therefore requiring lower total locking force for the injection mold, and less capital expenditure for the injection molding machine.

Alongside the improvements in the injection molding process, the lowering of melt viscosity can lead to marked advantages in the actual design of the molding. For example, injection molding can be used to produce thin-walled applications which, for example, could not hitherto be produced using filled grades of polyester. Similarly, the use of reinforced but free-flowing grades of polyester in existing applications can reduce wall thicknesses and therefore reduce component weights.

The inventive blends are suitable for production of fibers, films, or moldings of any type, in particular for applications as plugs, switches, housing parts, housing covers, headlamp bezzles, shower heads, fittings, smoothing irons, rotary switches, stove controls, fire lids, door handles, (rear) mirror housings, tailgate screen wipers, sheathing for optical conductors.

Electrical and electronic devices which can be produced using the improved-flow polyesters are plugs, plug components, plug connectors, cable harness components, circuit mounts, circuit mount components, three-dimensionally injection-molded circuit mounts, electrical connector elements, mechatronic components, and optoelectronic components.

Possible uses in automobile interiors are dashboards, steering-column switches, seat components, headrests, center consoles, gearbox components, and door modules, and possible automobile exterior components are door handles, headlamp components, exterior mirror components, windshield washer components, windschield washer protective housings, grilles, roof rails, sunroof frames, and exterior bodywork parts.

Possible uses for the improved-flow polyester in the kitchen and household sector are production of components for kitchen equipment, e.g. friers, smoothing irons, buttons, and also garden and leisure sector applications, such as components for irrigation systems or garden equipment.

In the medical technology sector, improved-flow polyesters means easier production of inhaler housings and components of these.

The morphology of selected inventive blends was studied via transmission electron micrographs. Good dispersion of the particles in the blend is seen. Particle sizes of from 20 to 500 nm were observed.

The invention also provides the use of the linear, oligomeric polycarbonates as defined as component B), for increasing the flowability of polyesters.

### EXAMPLES

### Component A

Polybutylene terephthalate (PBT) with a viscosity number VN of 130 ml/g, measured to DIN 53728 or ISO 1628 on a 0.5% strength by weight solution in a 1:1 mixture of phenol and o-dichlorobenzene at 25° C., and with carboxy end group content of 34 meq/kg. The commercially available product Ultradur® B 4520 from BASF was used. The PBT comprised

### Component C:

Based on 100% by weight of component A, 0.65% by weight of pentaerythritol tetrastearate.

### Component B:

A three-necked flask was used, with stirrer, reflux condenser, and internal thermometer. 1 mol of the diol (see table 1) was used as initial charge, and 1 mol of diethyl carbonate and 0.1 g of potassium carbonate were added, with stirring, and the mixture was heated to 130° C. The reaction mixture was stirred for 2 hours, and during this process the temperature of the mixture fell as a result of onset of evaporative cooling of the ethanol liberated. After the 2 hours mentioned, the reflux condenser was replaced by an inclined condenser, and the ethanol was removed by distillation, during which process the temperature of the mixture was slowly increased to 180° C.

The ethanol removed by distillation was collected in a cooled round-bottomed flask, and weighed, and conversion was thus determined in comparison with the full conversion theoretically possible, see table 1.

The molecular weight of the reaction product was determined as follows: weight average Mw and number average Mn via gel permeation chromatography at 20° C. using four columns arranged in series (2×1000 Å, 2×10 000 Å), each column 600×7.8 mm, PL-Gel from Phenomenex; eluent: dimethylacetamide, 0.7 ml/min, standard: polymethyl methacrylate (PMMA)

The glass transition temperature Tg of the reaction product was determined via differential scanning calorimetry (DSC) to ASTM 3418/82, evaluating the second heating curve.

TABLE 1
Linear oligomeric polycarbonate B

| Component | B1 | B2 |
|---|---|---|
| Diol | 1,3-Propanediol | 2,2-Diethyl-1,3- |
| | | propanediol |
| Conversion [%] | 80 | 72 |
| Mol. weight Mn [g/mol] | 1217 | 642 |
| Mol. weight Mw [g/mol] | 2045 | 1036 |
| Mw/Mn | 1.7 | 1.6 |
| Glass trans. temp. Tg [° C.] | 11.2 | 64.7 |

### Component C2:

Glass fibers of average length 4 mm and average diameter 4 μm. The commercially available product Cratec® Plus chopped strands from Owens Corning Fibers was used.

### Component X (Instead of B) for Comparison:

The flow improver Joncryl® ADF 1500 from Johnson Polymers was used: a styrene copolymer with a molar mass Mw of 2800 g/mol and a glass transition temperature Tg of 56° C.

### Preparation and Properties of Blends

The components were homogenized at 260° C. in accordance with the constitutions mentioned in table 2 in a ZSK 25 twin-screw extruder from Werner & Pfleiderer, and the mixture was extruded into a waterbath, pelletized, and dried. The pellets were used in an injection molding machine at 260° C. melt temperature and 80° C. mold surface temperature to injection-mold test specimens, which were then tested.

The following properties were determined:
Viscosity number VN, measured to ISO 1628 on a 0.5% by weight solution in a 1:1 mixture of phenol and o-dichlorobenzene at 25° C.
Melt viscosity, measured at 260° C. melt temperature and at varying shear (oscillating) in a SR5000 parallel plate rheometer from Rheometric Scientific with 25 mm plate diameter and height h=1 mm, preheat time: 1 min, measurement time: 20 min at 260° C.,
Melt volume ratio (MVR) at 275° C. melt temperature and with 2.16 kg load to EN ISO 1133.
Tensile stress at break, tensile strain at yield, and modulus of elasticity, in the tensile test on dumbbell specimens at 23° C. to ISO 527-2:1993.
Notched impact resistance aₖ at 23° C. to ISO 179-2/1eA(F).
Flowability via the spiral test: a test spiral of diameter 2 mm is produced, using an injection-molding machine at a polymer melt temperature of 260° C. and a mold-surface temperature of 80° C., and the length of the resultant spiral is then determined. The longer the spiral, the higher the flowability of the polymer.

The constitutions and the results of the measurements are given in table 2.

TABLE 2
Constitution and properties (comp. for comparison, nd not determined)

| Example | | | | | | |
|---|---|---|---|---|---|---|
| 1 comp. | 2 | 3 | 4 | 5 | 6 | 7 |

Composition [% by weight]

| | | | | | | | |
|---|---|---|---|---|---|---|---|
| Component A + C1¹⁾ | 100 | 99 | 98.5 | 98 | 99 | 98.5 | 98 |
| Component B1 | — | 1 | 1.5 | 2 | — | — | — |
| Component B2 | — | — | — | — | 1 | 1.5 | 2 |
| Component C2 | — | — | — | — | — | — | — |
| Component X | — | — | — | — | — | — | — |

Properties

| | | | | | | | |
|---|---|---|---|---|---|---|---|
| VN | 123 | 105 | 93 | 85 | 113 | 111 | 106 |
| [ml/g] | | | | | | | |
| Viscosity η₀ [Pa · s] | 350 | 129 | nd | 37 | 261 | nd | 221 |
| MVR²⁾ | 60 | 139 | 250 | 250 | 115 | 142 | 198 |
| [cm³/10 min] | | | | | | | |
| Tensile stress at break | 30 | 48 | 56 | 53 | 37 | 48 | 50 |
| [N/mm²] | | | | | | | |
| Tensile strain at yield [%] | 3.7 | 6.4 | 6.5 | 4.7 | 3.8 | 7.5 | 9.1 |
| Modulus of elasticity | 2507 | 2500 | 2451 | 2364 | 2522 | 2464 | 2391 |
| [N/mm²] | | | | | | | |
| Notched impact res. aₖ | 3.8 | 3.3 | 2.9 | 2.1 | 3.4 | 3.3 | 3.2 |
| [kJ/m₂] | | | | | | | |
| Spiral: Length of spiral | 38 | 52 | 70 | 82 | 48 | 51 | 60 |
| [cm] | | | | | | | |

| Example | | | | | |
|---|---|---|---|---|---|
| 8 comp. | 9 | 10 | 11 | 12 comp. | 13 comp. |

Composition [% by weight]

| | | | | | | |
|---|---|---|---|---|---|---|
| Component A + C¹⁾ | 70 | 69 | 69 | 68.5 | 99 | 98 |
| Component B1 | — | 1 | — | — | — | — |
| Component B2 | — | — | 1 | 1.5 | — | — |
| Component C2 | 30 | 30 | 30 | 30 | — | — |
| Component X | — | — | — | — | 1 | 2 |

Properties

| | | | | | | |
|---|---|---|---|---|---|---|
| VN | 102 | 98 | 104 | 100 | 122 | 122 |
| [ml/g] | | | | | | |
| MVR²⁾ | 18 | 59 | 49 | 57 | 26 | 24 |
| [cm³/10 min] | | | | | | |
| Tensile stress at | 141 | 141 | 132 | 137 | 58 | 58 |
| break [N/mm²] | | | | | | |
| Tensile strain at yield | 3.1 | 2.8 | 2.9 | 2.7 | 3.6 | 3.6 |
| [%] | | | | | | |
| Modulus of elasticity | 10083 | 10117 | 9744 | 9825 | 2538 | 2563 |
| [N/mm²] | | | | | | |
| Notched impact res. | 67 | 71 | 66 | 67 | 4.5 | 5.3 |
| aₖ [kJ/m₂] | | | | | | |
| Spiral: Length of spi- | 25 | 38 | 49 | 39 | 35 | 34 |
| ral [cm] | | | | | | |

¹⁾Component A comprises 0.65% by weight of pentaerythritol tetrastearate as component C1
²⁾Melt temperature 275° C., nominal load 2.16 kg

The examples show that even 1.5% by weight of the linear, oligomeric polycarbonate B1 increased flowability, measured in the flow spiral test, by 84% (comparison of example 1comp. with example 3). Similarly, 1.5% by weight of polycarbonate B2 increased flowability by 34% (example 1comp. compared with example 6). Flowability increased again at higher contents of polycarbonate B.

The increase in flowability was particularly pronounced in the case of blends comprising glass fibers. For example, flowability increased by 96% (example 8comp. compared with 10) via addition of only 1% by weight of polycarbonate B2.

The advantageous mechanical properties of the moldings were retained here, i.e. improved flowability was not obtained at the cost of poorer mechanical properties.

In contrast, a commercially available flow improver (component X) did not improve flowability, as shown by the flow spiral values of examples 1comp. 12comp. and 13comp.

1. A polymer blend, comprising components A) to C), the entirety of which gives 100% by weight,
A) from 30 to 99.99% by weight of at least one polyester A),
B) from 0.01 to 30% by weight of at least one linear, aliphatic, oligomeric polycarbonate B), whose number-average molar mass is from 300 to below 10 000 g/mol, and
C) from 0 to 50% by weight of other additives C).

2. The polymer blend according to claim 1, wherein the polyester A) is aromatic.

3. The polymer blend according to claim 1, wherein the polyester A) is selected from polyethylene terephthalate and polybutylene terephthalate.

4. The polymer blend according to claim 1, wherein the polycarbonate B) has a melting point or glass transition temperature of from −20 to 120° C., determined using DSC according to ASTM 3418/82.

5. The polymer blend according to claim 1, wherein the polycarbonate B) is obtained by reacting a diol with an organic carbonate.

6. The polymer blend according to claim 5, wherein the diol is selected from the group consisting of 1,3-propanediol, 2,2-diethyl-1,3-propanediol, and mixtures thereof.

7. The polymer blend according to claim 5, wherein the organic carbonate is selected from the group consisting of dimethyl carbonate, diethyl carbonate and mixtures thereof.

8. A method for production of moldings, of films, of fibers, or of foams comprising utilizing the polymer blend according to claim 1 during the production process.

9. A molding, a film, a fiber, or a foam, obtainable from the polymer blend according to claim 1.

10. A method for increasing the flowability of polyesters comprising adding a linear, aliphatic oligomeric polycarbonate to a polyester wherein the number-average molar mass of the polyester is from 300 to below 10 000 g/mol.

11. The polymer blend according to claim 2, wherein the polyester A) is selected from polyethylene terephthalate and polybutylene terephthalate.

12. The polymer blend according to claim 2, wherein the polycarbonate B) has a melting point or glass transition temperature of from −20 to 120° C., determined using DSC according to ASTM 3418/82.

13. The polymer blend according to claim 3, wherein the polycarbonate B) has a melting point or glass transition temperature of from −20 to 120° C., determined using DSC according to ASTM 3418/82.

14. The polymer blend according to claim 2, wherein the polycarbonate B) is obtained by reacting a diol with an organic carbonate.

15. The polymer blend according to claim 3, wherein the polycarbonate B) is obtained by reacting a diol with an organic carbonate.

16. The polymer blend according to claim 4, wherein the polycarbonate B) is obtained by reacting a diol with an organic carbonate.

17. The polymer blend according to claim 6, wherein the organic carbonate is selected from the group consisting of dimethyl carbonate, diethyl carbonate and mixtures thereof.

18. The method as claimed in claim 10, wherein the polycarbonate B) is obtained by reacting a diol with an organic carbonate.

19. The method as claimed in claim 10, wherein the polycarbonate B) is obtained by reacting a diol with an organic carbonate.
